(19) United States
(12) Patent Application Publication
(10) Pub. No.: US 2010/0106543 A1
(43) Pub. Date: Apr. 29, 2010

(54) BUILDING MANAGEMENT CONFIGURATION SYSTEM

(75) Inventor: Jerry Marti, West Salem, OH (US)

Correspondence Address: HONEYWELL/CST;Patent Services, 101 Columbia Road, P.O. Box 2245, Morristown, NJ, 07962-2245, US

(73) Assignee: HONEYWELL INTERNATIONAL INC., Morristown, NJ (US)

(21) Appl. No.: 12/260,046

(22) Filed: Oct. 28, 2008

(51) Int. Cl. G06Q 10/00; G06F 15/16; G05B 15/02; G06F 15/177; G05D 23/00

(52) U.S. Cl. 705/7; 715/736; 715/855; 700/276; 715/825; 715/735; 705/1.1

(57) ABSTRACT

An approach to create, deploy and manage separate control system components within a hierarchical context of a multi business and/or multi site environment. This approach may be incorporated into an architecture having one or more workstations, controllers, servers and so forth. Components of the approach may include business groups, sites and executives.

### BACKGROUND

The invention pertains to management schemes and particularly to business and/or building management.

### SUMMARY

The present invention is for providing a user an approach to create, deploy and manage separate control system entities within a hierarchical context of a multi-business and/or multi-site environment. This approach may be incorporated into an architecture having one or more workstations, controllers, servers, and so forth.

### BRIEF DESCRIPTION OF THE DRAWING

FIG. 1 is a screen diagram of a related art user application navigation view;

FIG. 2 is a screen diagram of a related art user application alarm view;

FIG. 3 is a screen diagram of a present user application showing multiple businesses;

FIG. 4 is a screen diagram of a present user application showing multiple sites;

FIG. 5 is a screen diagram of a present user application showing multiple executives;

FIG. 6 is a screen diagram of a present user application alarm view;

FIG. 7 is diagram of a deployment architecture overview of the present system;

FIGS. 8 and 9 are diagrams of system configuration, site controller deployment, and runtime activities;

FIG. 10 is a diagram of a screen showing no pre-existing configuration;

FIG. 11 is a diagram of a screen showing a menu option for creating a business group;

FIG. 12 is a diagram of a screen showing a box for entering the group name and number;

FIG. 13 is a diagram of a screen showing the results from creating a group component;

FIG. 14 is a diagram of a screen showing a menu for adding a new site;

FIG. 15 is a diagram of a screen showing a box for entering the site name and number;

FIG. 16 is a diagram of a screen showing a creation of a site component;

FIG. 17 is a diagram of a screen showing a menu for adding a creating an executive;

FIG. 18 is a diagram of a screen showing a box for entering the executive name and number;

FIG. 19 is a diagram of a screen showing the resultant executive added;

FIG. 20 is a diagram of a screen showing the adding the site controller specific configurations prior to download;

FIG. 21 is a diagram of a screen showing lines for the entering the address of the site controller to prepare for download;

FIG. 22 is a diagram of a screen showing a menu for downloading to the site controller;

FIG. 23 is a diagram of a screen showing the download and automatic backup of the site controller after a download to it;

FIG. 24 is a diagram of a screen showing the components in the downloaded site controller;

FIG. 25 is a diagram of a screen showing a basis of navigation for accessing the site controller; and

FIG. 26 is a diagram of a screen showing an alarm console view with alarms differentiated by the group, site and xcm names of where each alarm came from.

### DESCRIPTION

The Tridium Niagara™ AX framework is the base application framework to develop the multi-business/multi-site application that is described herein. The related art implementation of Niagara™ AX is to provide configuration, control and monitoring of embedded DDC (direct digital control) controllers within the context of a single executive level JACE™. JACE may refer to “Java application and control engine”. Each JACE contains references to subordinate embedded field controllers within its respective network to perform the specified control functions. JACE and its subordinates may be referred to as the “control system” entity. This described control system may typically be deployed within a single geographical site. However, a site may have multiple control systems.

A Niagara™ AX supervisor application may be deployed providing the user interface and a runtime environment providing some supervisory control level capabilities for multiple control systems accessible within a supervisor's network. A supervisor may collect alarms and historical logs from multiple deployed control systems to be viewed by a user of the supervisor application. Each JACE executive controller may be configured to communicate with this supervisor application as needed.

An issue may be noted in the following. Within the related art, the Niagara™ AX user application experience, each control system entity may be managed as an independent entity with the JACE being the highest level contextual entity. The supervisor application is limited to manage the multiple control systems within a single, flat hierarchal list of control system entities. By default, the user application provides limited means to manage these control system entities within a context that matches the user's logical, multi-site deployment environment. If a user's business has hundreds or thousands of sites, they would need to manage these sites in a single linear list with business and site identification embedded in the naming of the individual control system entity. A user may also have multiple business groups that have hundreds or thousands of sites. Managing a large list of un-related business control system entities may be difficult for the user to do. The supervisor application may also collect alarms and data trend logs from these thousands of sites. The historical logs may be persisted into storage and be accessible for viewing by the supervisor. Without the customer and site context attached to these historical data points, the analysis of where an alarm or data log originated may be difficult for the user.

A solution of the present system is to provide the user the ability to create, deploy and manage these separate control system entities within the logical context of the user's multi-business and/or multi-site enterprise environment. A typical business may have hundreds or even thousands of sites with each site generally having from one to five control system entities. The present application may provide the user the means to create and manage each of the deployed control system entities in a user definable hierarchal structure in order to maintain and access the control system entities within their proper business and geographical context.

The enterprise model components of business, site and executive may be created as entity objects to represent each logical hierarchal level required for the user's environment. These new components may be created and managed within a supervisor application. The user may be provided properties associated with each of these components to personalize the specific business, site and control system entities. The new user application may provide a navigation and menu system to add, change or delete these components. At the end leaf of the enterprise model, the user may create an executive controller which may be a baseline Niagara™ AX JACE station configuration. This station may be the control system configuration file to be deployed to the control system at the site. When the control system configuration file is deployed to the site control system, the enterprise model components specific to that control system may also be downloaded into the controller. This may enable the controller to associate the enterprise context to historical alarms and trend logs that are pushed or polled to a runtime supervisor application.

The user application may provide an explorer type tree menu allowing the user to create and manage a personalized list of business groups, site lists and control system (i.e., executive) lists. Also, a navigation table view may be provided to allow the customer to browse its business, site and control systems. The application may provide the user other management features.

The present solution may allow the user to build an enterprise structure in accordance with the hierarchal entity relationships of the actual businesses the user manages. The user may have a business group that contains one or more sites. The site entity may contain one or more executive controllers (i.e., site controllers).

The present description may utilize screen diagrams to convey a concern with the existing user interface application management of multiple businesses, sites and executives and how the present software application enhances the user's ability to manage these entities. The “existing user” application refers to the related art application that needs the solution that the present approach is based on. A “new user” or “present” application refers to the solution stated herein.

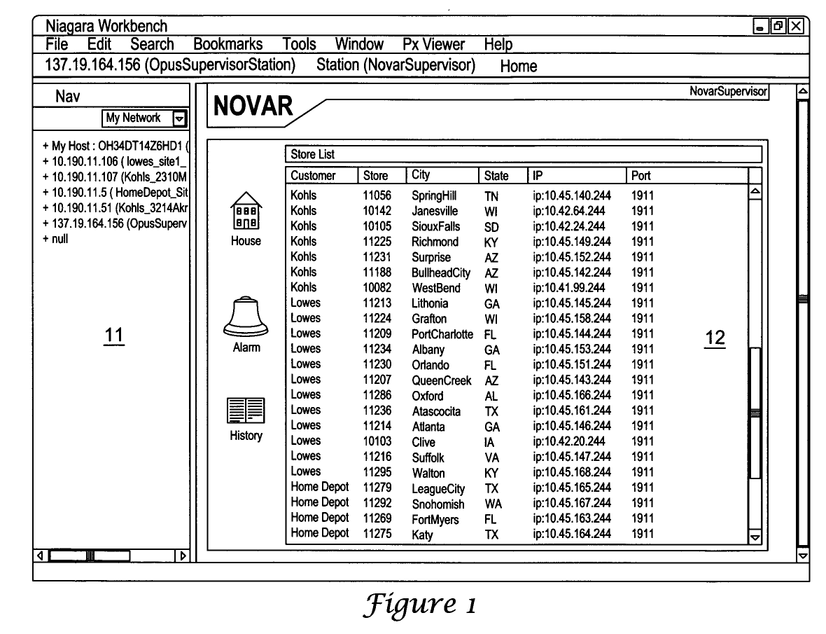

FIG. 1 is a screen diagram of an “existing user” application navigation view. Both the left side navigation tree view 11 and the main window table view 12 provide flat lists of businesses, sites and executives.

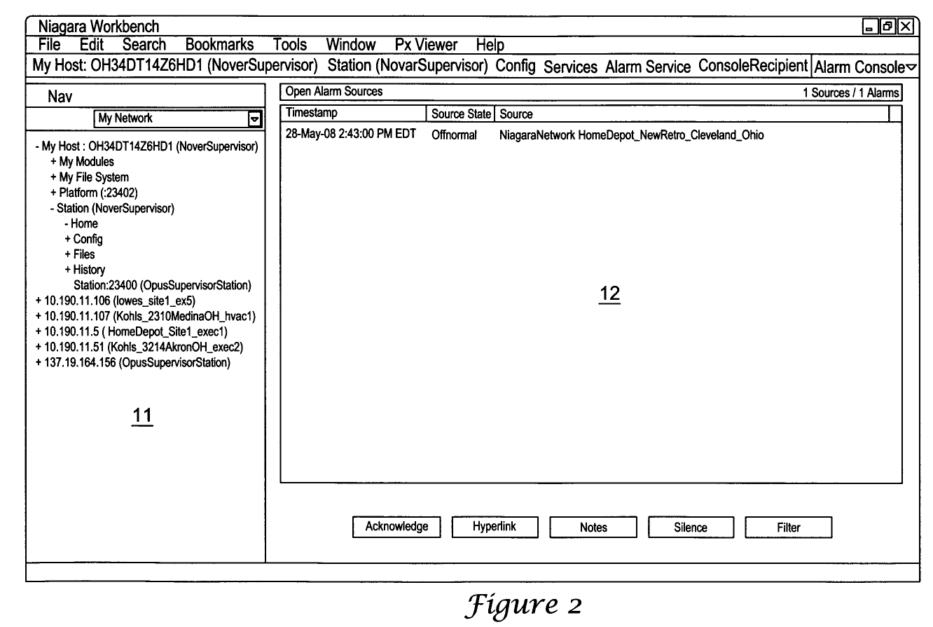

FIG. 2 is a screen diagram of an existing user application alarm in view 12. The existing application allows the user to view virtually all alarms collected in the supervisor (Niagara AX) from the deployed executives from the business sites. The business, site and executive information in view 12 is only embedded into the source JACE station name by the best practices of user.

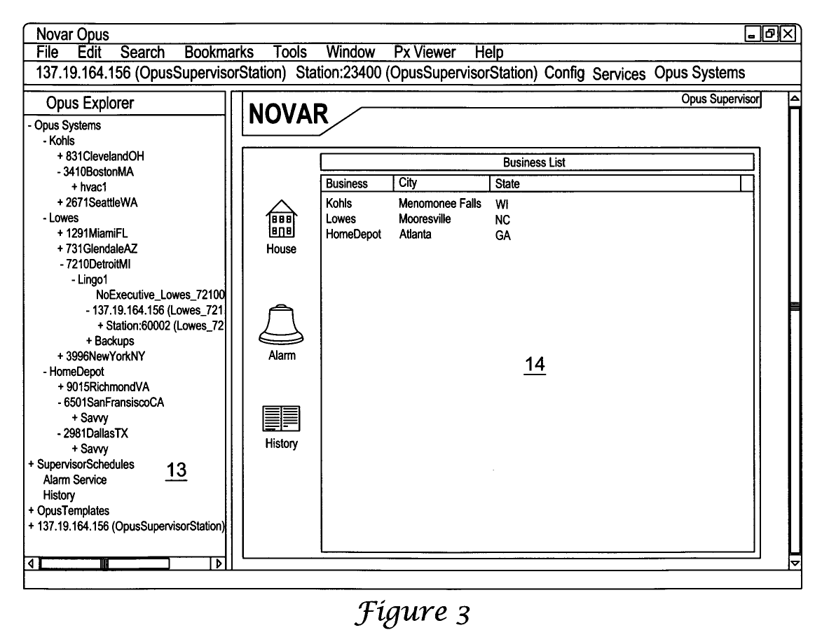

FIG. 3 is a screen diagram of a “new user” application showing multiple businesses. By creating a business, site and executive entity component model, the new user application may provide extended features that could not be easily managed without these components. Hierarchal views of the user's enterprise may now easily be developed allowing quicker access to information about a site executive of interest. Such a view provides the top level list of businesses the user manages. The left navigation tree in view 13 and the main window table in view 14 may allow for navigation in a hierarchal manner. The business entities or groups are at the top level. This provides a logical starting point for user access. View 13 shows the explorer and view 14 shows the supervisor's navigation table.

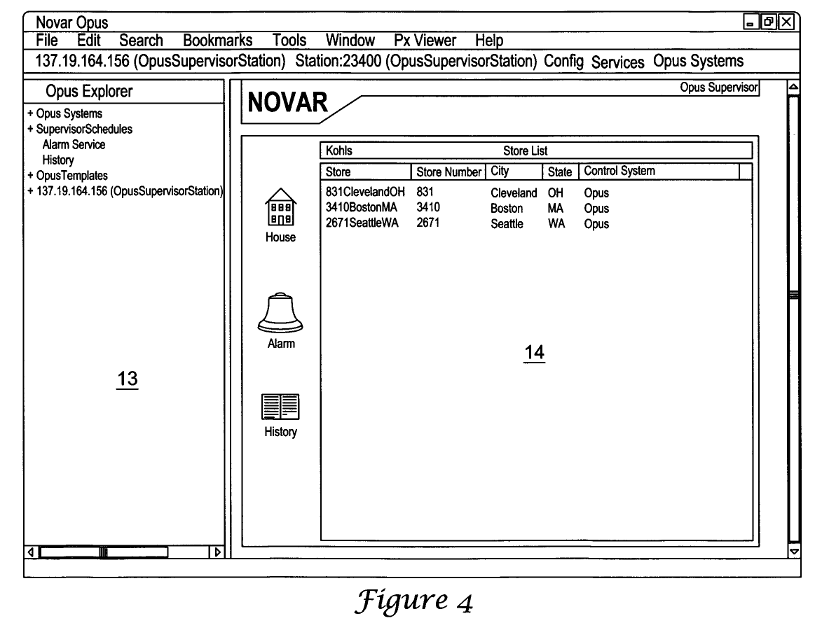

FIG. 4 is a screen diagram of the new user application showing multiple sites. This is the second screen in the enterprise model hierarchy and is rendered when the user selected a business in the previous screen. This just shows those sites that have been created and/or deployed for that business. This is the specified business site list in view 14. Advanced filtering and/or sorting algorithms may be developed relative to these enterprise model components based on a combination of properties.

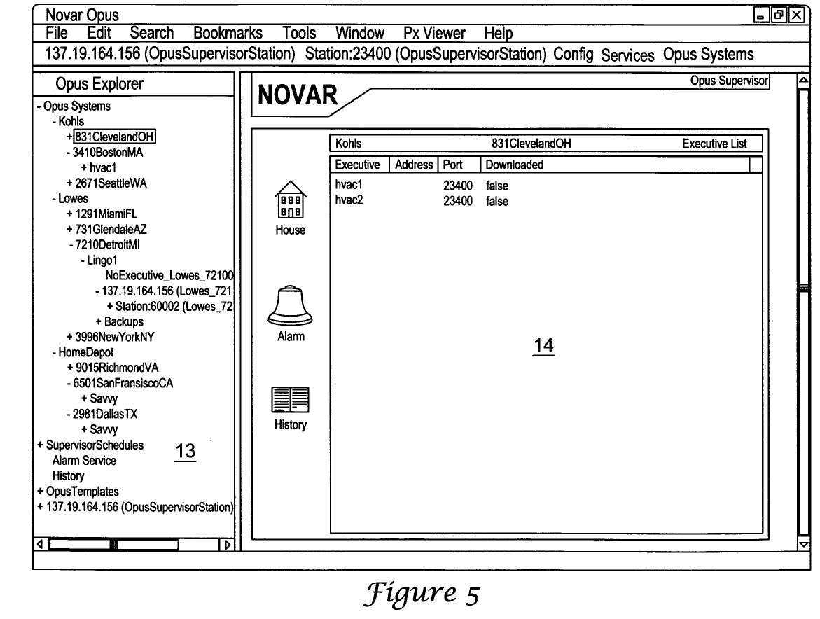

FIG. 5 is a screen diagram of a new user application showing multiple executives in view 14. This is the third screen in the enterprise model hierarchy and is rendered when the user has selected a site in the previous screen. This just shows those executives that have been created and/or deployed for that site. This may be the specified site controller list. Both the left navigation view 13 and the main table view 14 are navigation paths for connecting to the deployed executive controllers.

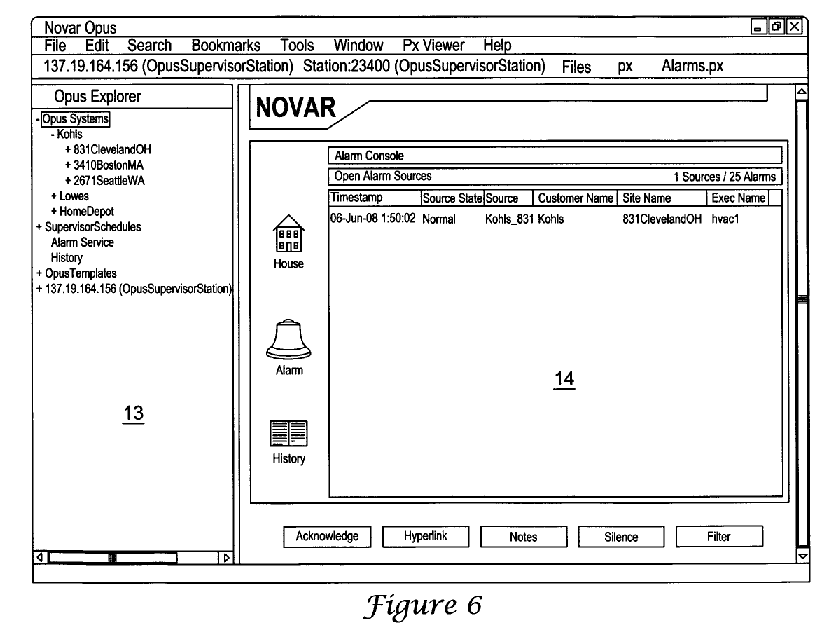

FIG. 6 is a screen diagram of a new user application alarm list view. The new application provides this alarm list in view 14 with the enterprise model entity names separated out as independent properties of the alarms. Using the common enterprise model entity names enforces consistency as opposed to user best practice to name the source stations appropriately for each deployed executive. Sorting and filtering may now be achieved against these independent properties.

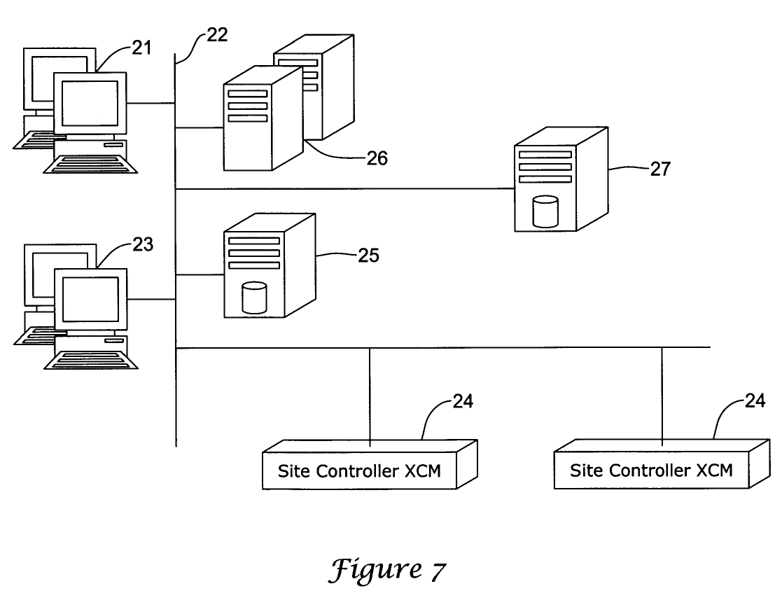

FIG. 7 is diagram of a deployment architecture overview of the present system. A user workstation 21 may be connected to a bus 22. A supervisor client application may be on workstation 21. The application may be used for site creation, configuration, deployment and monitoring. There may be one or more site controllers (XCMs—executive control modules) 24 connected to bus 22. There may be thin client browser 23 access for runtime monitoring of deployed site controllers.

A supervisor server 25 may be connected to bus 22. Server 25 may provide multi user access for both thick and thin client users. It may maintain a database of enterprise hierarchy components. Server 25 may provide an environment for deployment, backup and restore for site controllers. It may provide navigational access to deployed site controllers and provide supervisory functions such as global schedules. Provisioning services may also be provided for enterprise wide updates. Further, the server 25 may provide alarm and log collection. Optionally, a separate supervisor server 26 may be connected to bus 22 to provide for the alarm and log collection. An optional, MS-SQL database server 27 may be connected to bus 22 used for persisting alarms, logs and other configuration items.

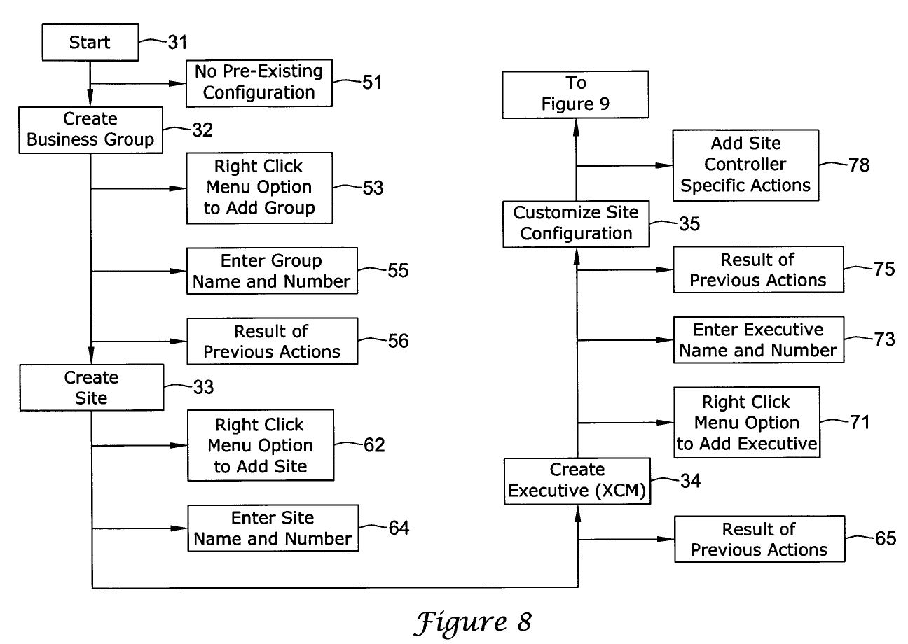

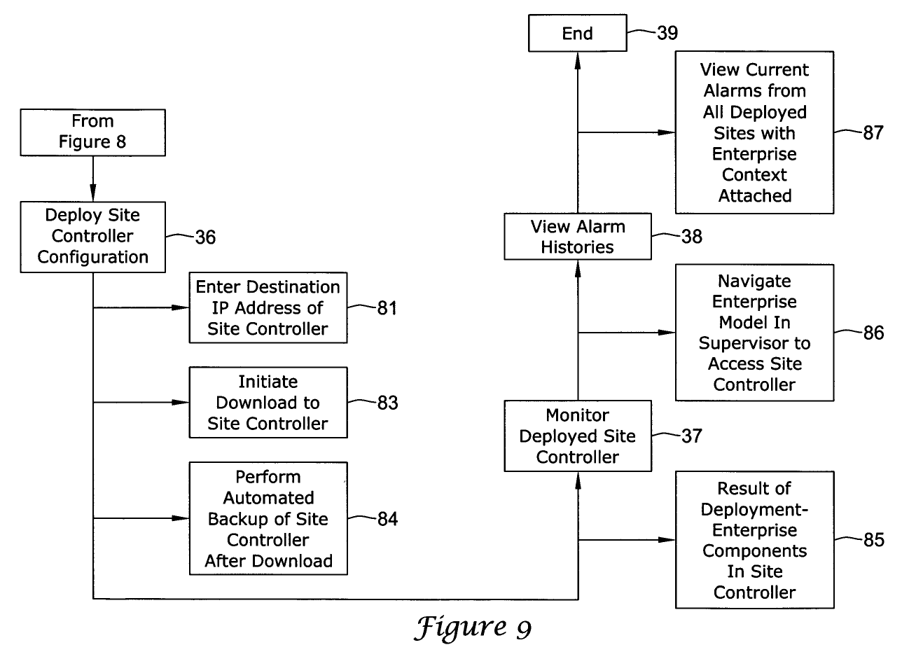

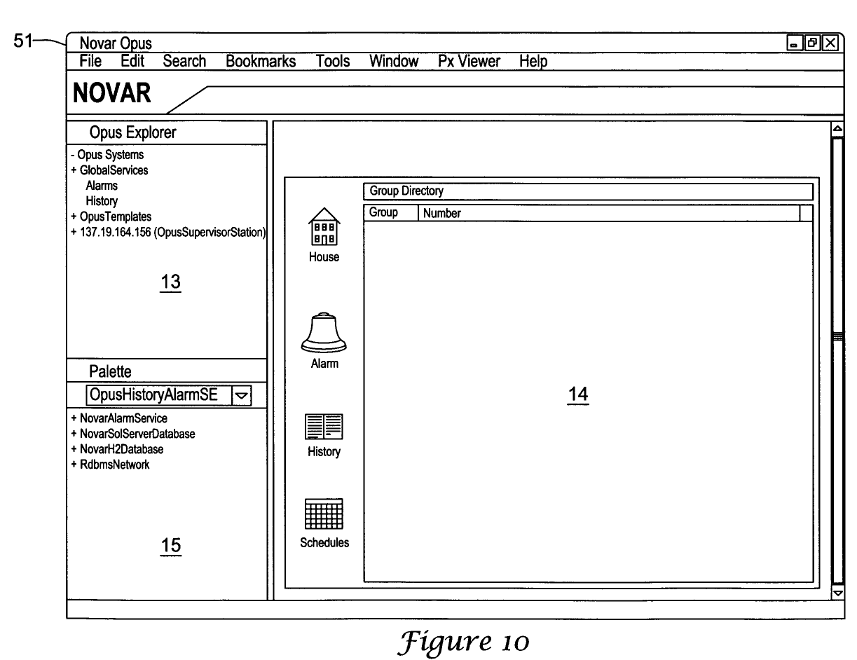

FIGS. 8 and 9 are diagrams of system configuration, site controller deployment, and runtime activities. The present management system may be used to create the enterprise component hierarchy, create the site controller “offline” to be configured for site specific needs and then finally to download that site controller configuration from the supervisor to the remote site controller. At a start 31, there is no pre-existing configuration as may be shown in screen 51 of FIG. 10. Incidentally, FIG. 10 shows a palette in a view 15 to be used for later configuration activities.

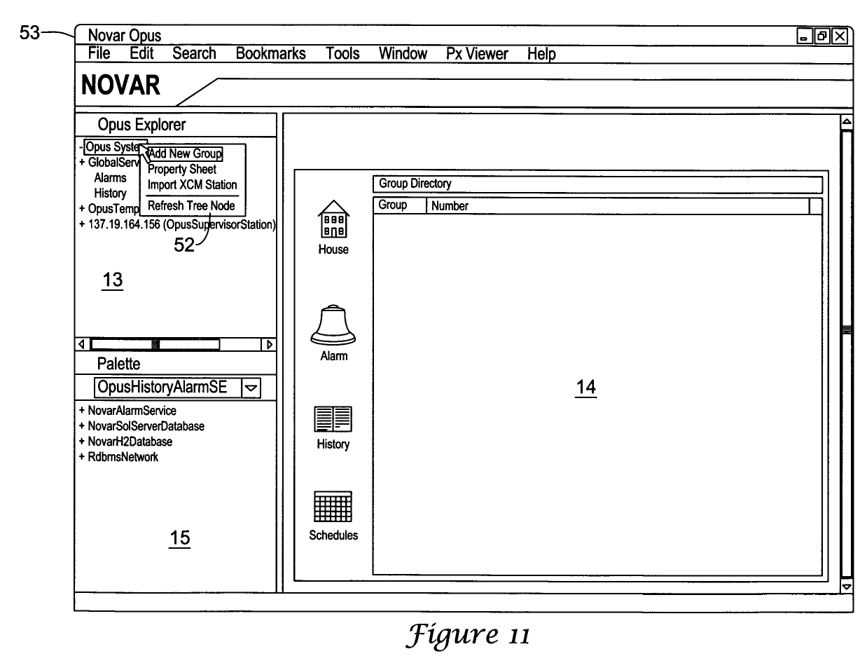

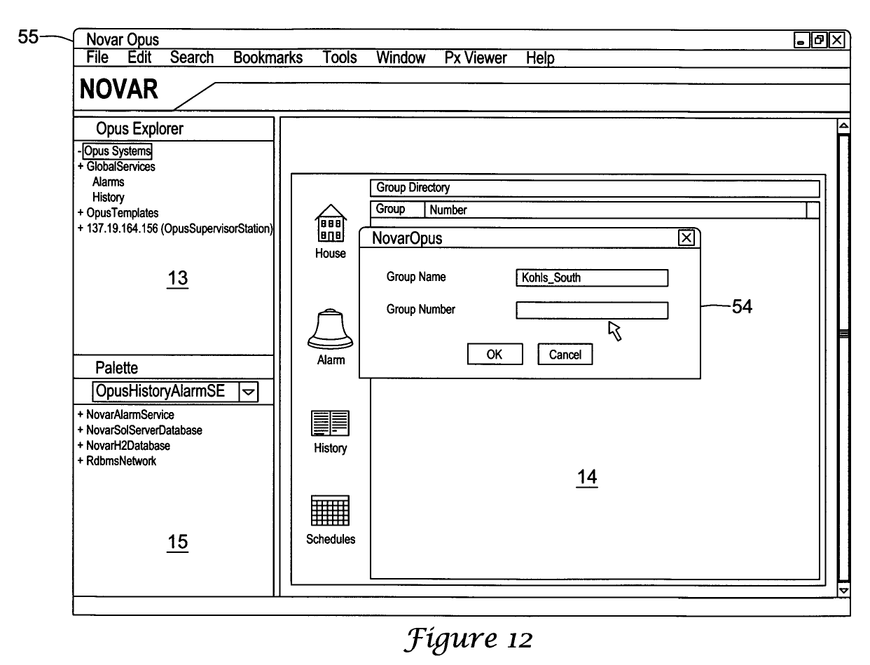

To create a business group at step 32, one may right click for the menu option to add the group as indicated by menu item 52 in screen 53 of FIG. 11. One may click “add new group” to get a box 54 in screen 55 of FIG. 12. The group name such as “Kohls-South” may be typed in box 54. Also, the group number may be entered.

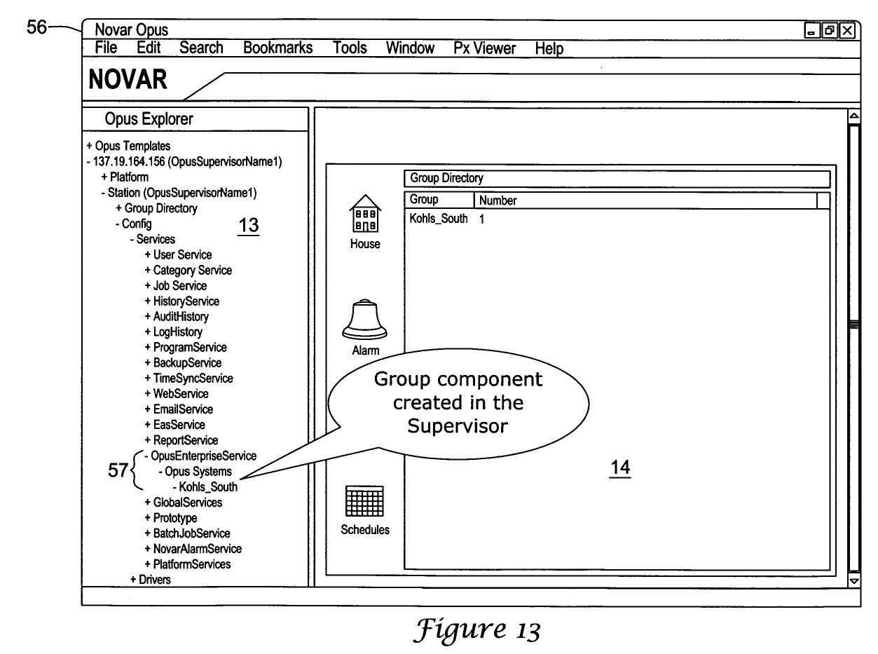

Screen 56 of FIG. 13 reveals the result of the previous actions which is a group component created in the supervisor. Lines 57 in view 13 show the hierarchy of enterprise service, the systems and Kohls_South group indicating the creation of the group component.

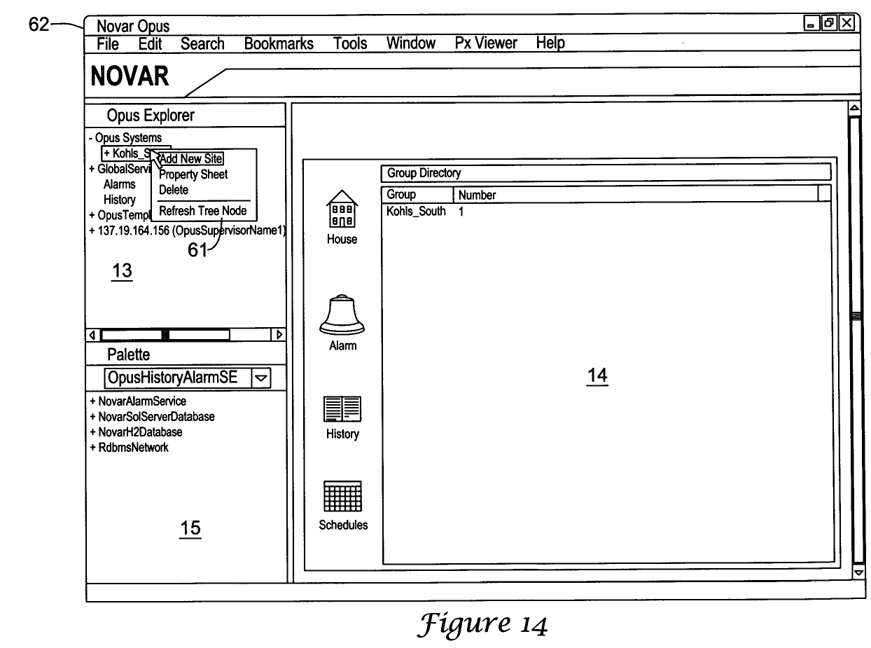

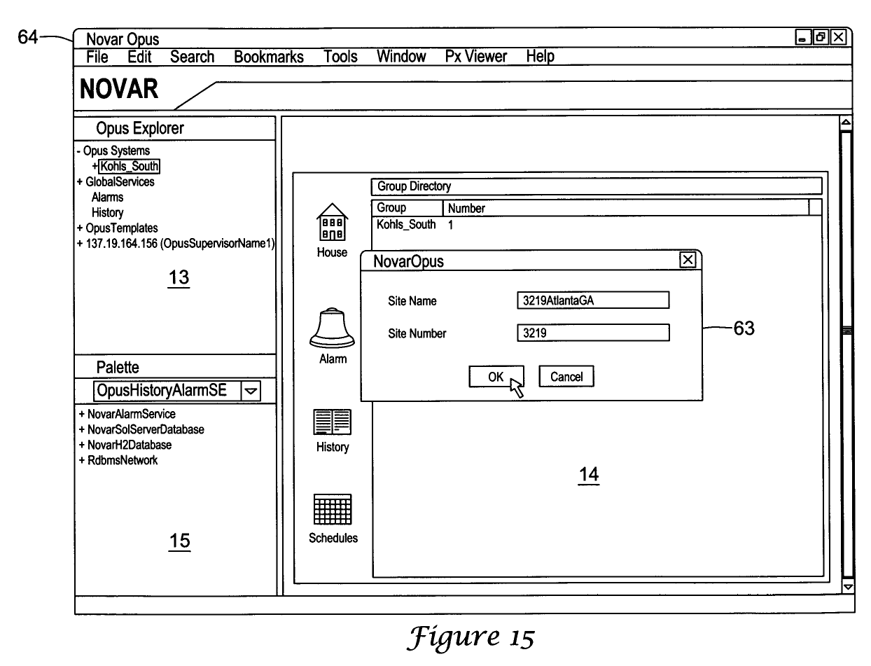

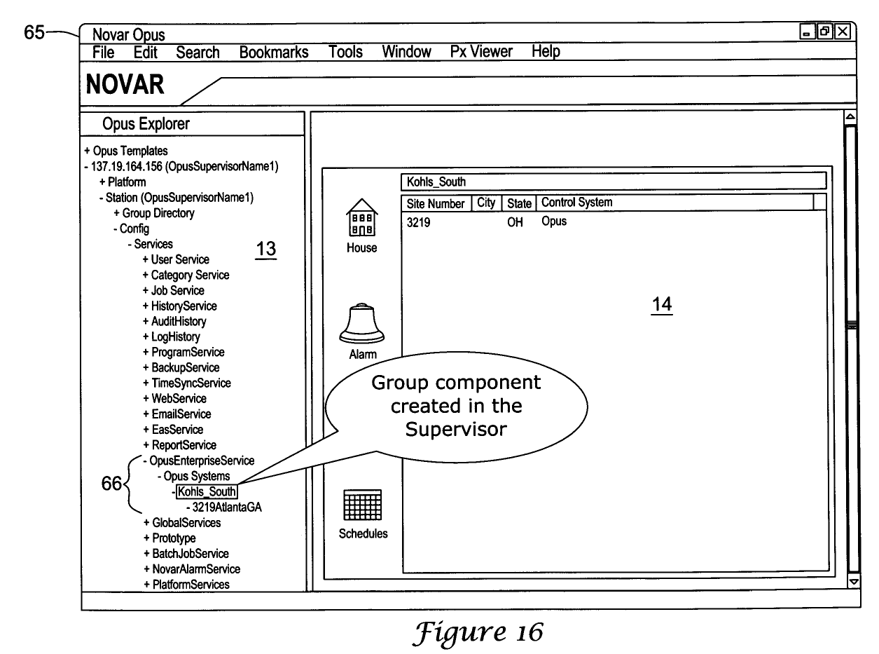

To create a site at step 33, one may right click on a group to invoke the menu option and add the new site by clicking at the first line of menu 61 in screen 62 of FIG. 14. A box 63 may show up as indicated in screen 64 of FIG. 15. The site name and number may be entered in box 63. “OK” in box 63 may be clicked to result in a screen 65 of FIG. 16. One may see that the site component is created in the supervisor. Lines 66 indicate an enterprise service, the systems, Kohls_South group and 3219AtlantaGa. site, in the explorer portion 13.

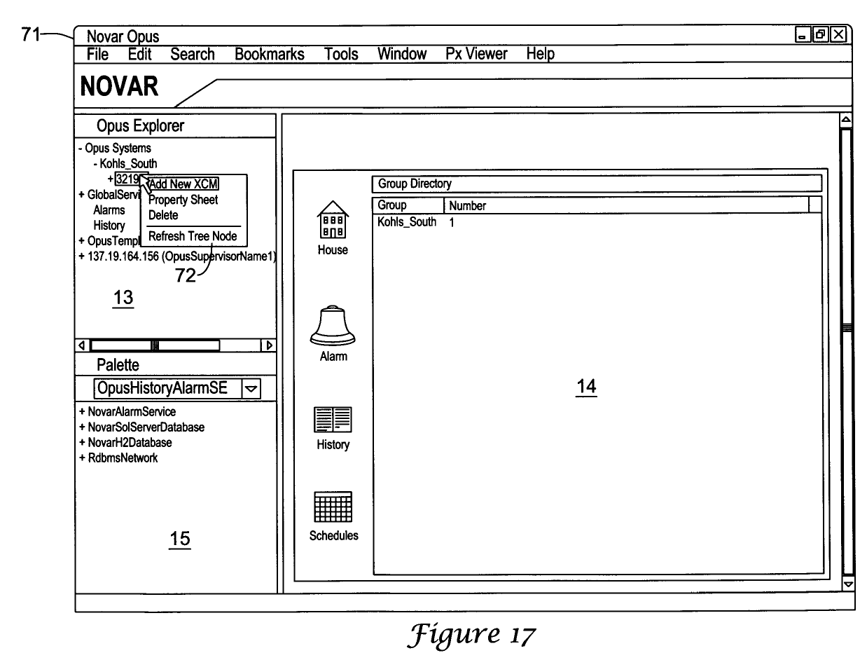

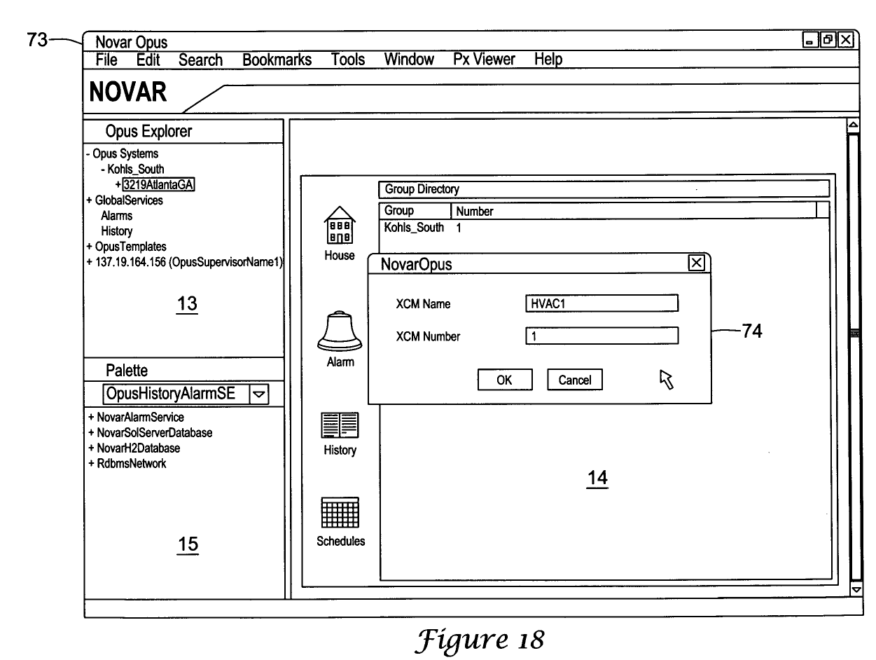

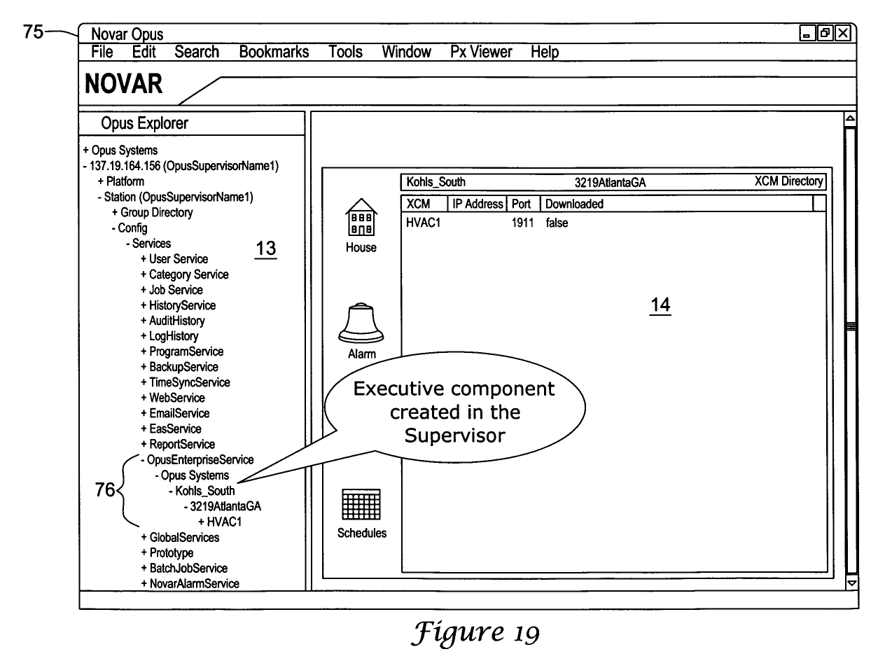

A next step 34 is for creating an executive (XCM). One may right click on a site to invoke a menu option on the site component line in portion 13 of screen 71 of FIG. 17 to get a box 72. The first line of box 72 showing “add new XCM” may be clicked on to add the executive. A box 74 in screen 73 of FIG. 18 may open request the executive (XCM) name and the XCM number. Those items may be filled in and the OK in box 74 be clicked on. A resulting screen 75 of FIG. 19 may show lines 76 in portion 13 which indicate the creating of an executive component in the supervisor. The executive may be an HVAC, site controller, building environment controller, or the like. Lines 76 show the enterprise service, the systems, Kohls_South group, 3219AtlantaGa. site and the HVAC1 executive (XCM) site controller. All of the last line of lines 76 might not always be shown.

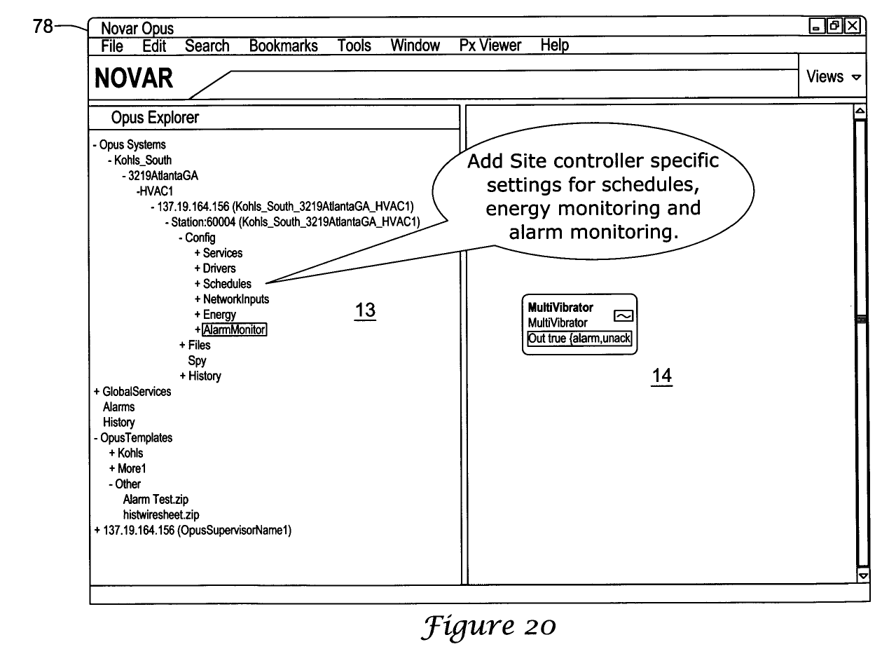

A step 35 may involve a customizing of the site configuration as indicated in screen 78 of FIG. 20. These customizations are the control configuration requirements specifically required by the target site controller.

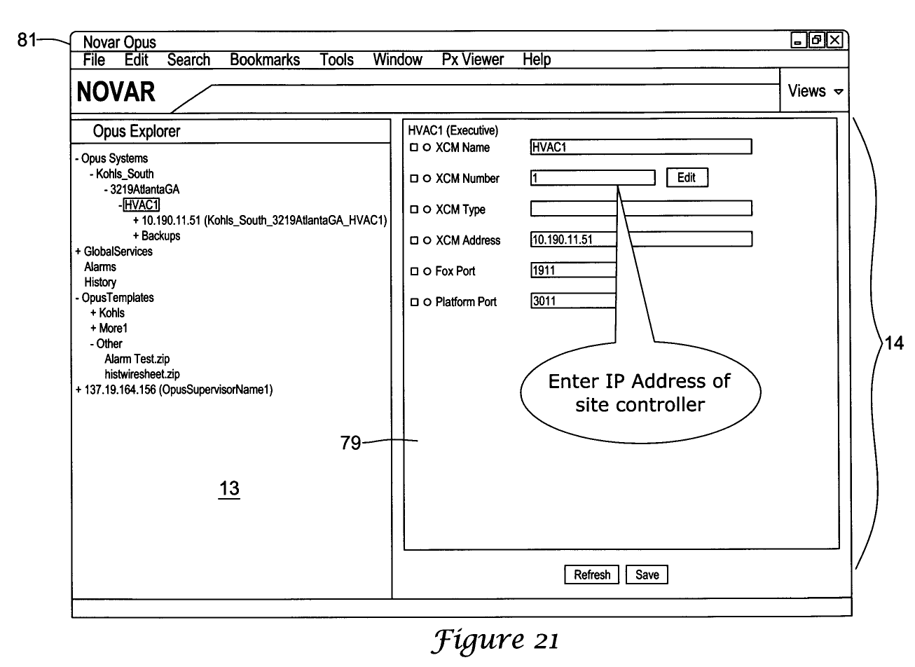

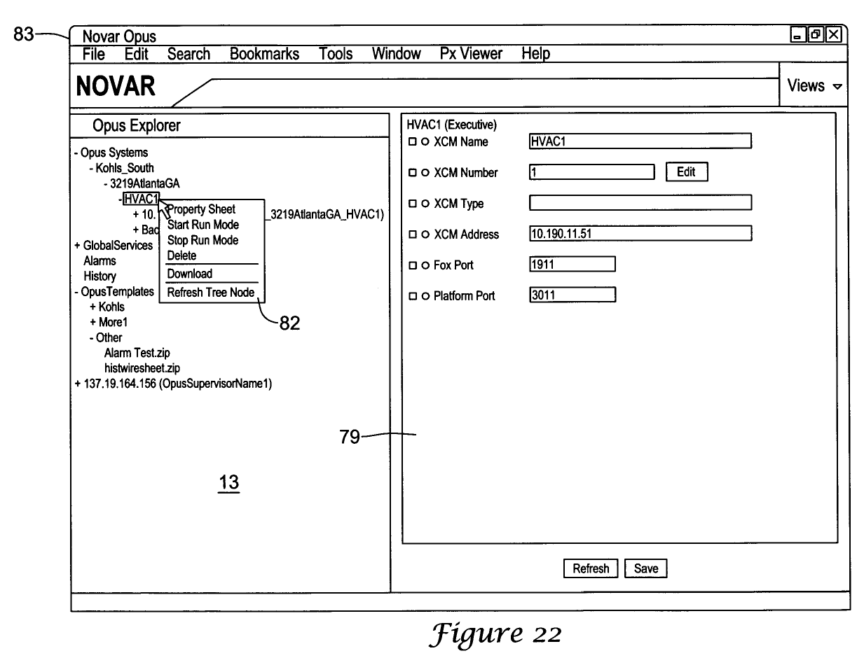

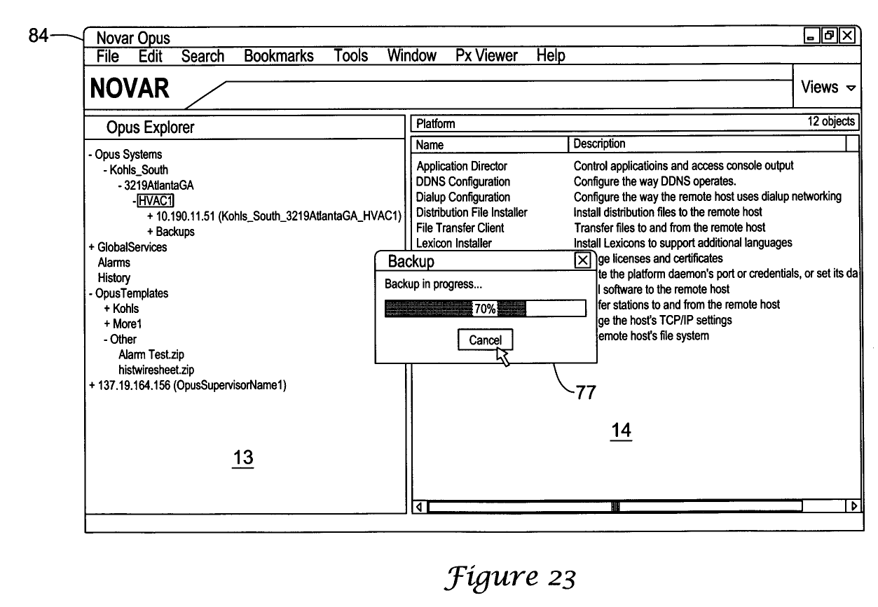

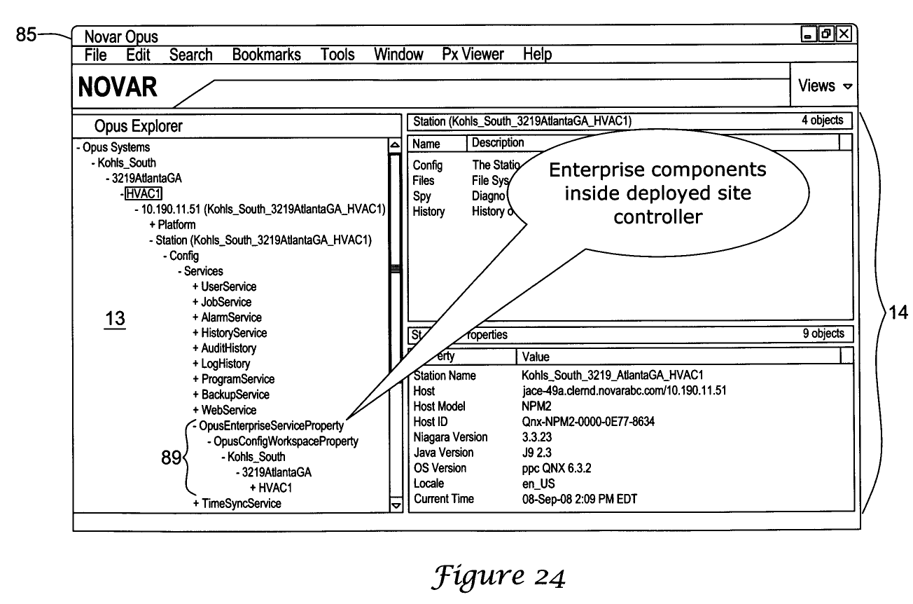

At step 36, a site controller configuration may be downloaded. A destination IP address of the site controller may be entered in portion 79 of view 14 in screen 81 of FIG. 21. A download to the site controller may be initiated by right clicking to get a menu 82 in view 13 of screen 83 of FIG. 22. The download may be initiated by clicking on the download line of menu 82. The download process will transfer the site controller configuration files from the supervisor to the remote executive (XCM) and then perform an automated backup of the site controller configuration may be performed after the download as indicated by box 77 in screen 84 of FIG. 23. As a result of the deployment, the enterprise components specific to that site controller (i.e., executive) are inside the deployed site controller as indicated by lines 89 in view 13 of screen 85 of FIG. 24.

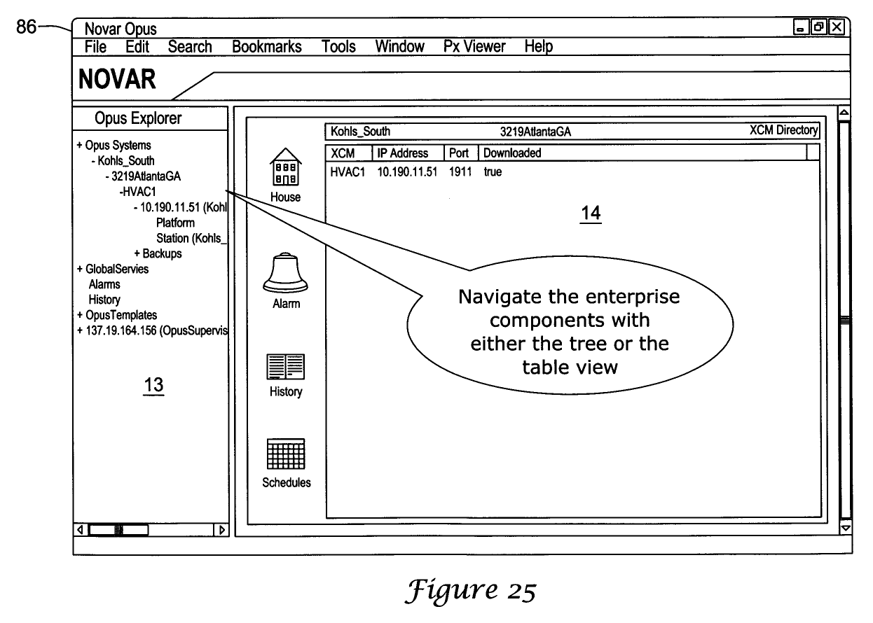

Runtime activities may be noted in steps 37 and 38. Step 37 may be to monitor the deployed site controller. One may navigate the enterprise model in the supervisor to access the site controller in screen 86 of FIG. 25. One may navigate the enterprise components with either the tree in view 13 or the table in view 14.

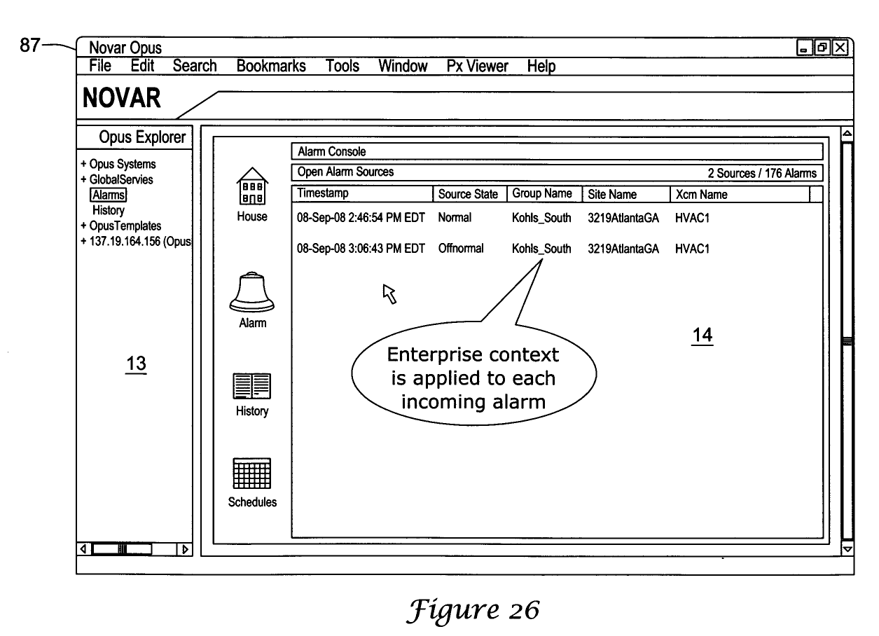

At step 38, the alarm histories may be viewed. In screen 87 of FIG. 26, the enterprise context may be applied to each incoming alarm in view 14. This view may reveal an alarm list which shows the current alarm sources. Shown may be a time stamp, a source state (i.e., normal or off normal), the group name, the site name, and the executive (XCM) name. At item 39, one may end the deployment.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A multi entity management configuration system comprising:
a hierarchical structure comprising one or more business groups; and
wherein:
each business group comprises one or more sites;
each site comprises one or more executives;
each site is a business entity having a geographical location; and
each executive is a building environment controller.

2. The system of claim 1, further comprising:
a navigation and menu system to add, change or delete components; and
wherein a component is a business group, site or executive.

3. The system of claim 1, further comprising creating an executive which is a baseline Niagara AX JACE station.

4. The system of claim 1, further comprising an explorer type tree menu for creating and managing a personalized list of business groups, sites and executives.

5. The system of claim 1, further comprising a navigation table for browsing lists of sites and executives of a business group in a hierarchical manner.

6. A building management configuration system comprising:
an enterprise structure; and
wherein:
the structure comprises business groups, sites and executive controllers;
the business groups, sites and executive controllers have a hierarchical relationship;
each site is a business entity having a geographical location; and
each executive controller is a building environment controller.

7. The system of claim 6, wherein:
a business group comprises one or more sites; and
a site comprises one or more executive controllers.

8. The system of claim 6, further comprising:
a screen on a display; and
wherein:
a navigational tree is situated in the screen;
business groups are at a top level of the tree;
sites are at a level lower than the top level; and
executive controllers are at a level lower than the level lower than the top level.

9. The system of claim 8, further comprising:
a navigation path for connection to deployed executive controllers; and
wherein:
the screen comprises first and second views;
the navigational tree is situated in the first view of the screen; and
the navigator path for connection to executive controllers is situated in the second view of the screen.

10. The system of claim 8, further comprising:
one or more alarms; and
wherein:
the screen comprises first and second views;
the navigational tree is situated in the first view of the screen; and
the one or more alarms are shown in the second view of the screen.

11. The system of claim 6, further comprising:
an architecture;
wherein:
the architecture comprises:
one or more workstations, connected to a bus, having a supervisor client application for providing a user interface; and
a supervisor server connected to the bus; and
the supervisor server maintains a database of hierarchical components which include business groups, sites and executive controller, provides for deployment, backup and restores for executive controllers, provides navigational access to deployed controllers, provides supervisory functions, and/or provides provisioning services for updates.

12. The architecture of claim 11, wherein:
the one or more workstations has a display for exhibiting a screen; and
a menu option in the screen may be clicked to add a business group, a site and an executive, controller in that order.

13. The architecture of claim 12, wherein:
one or more site specific configurations are added; and
a configuration of the site is deployed to result in components in the site.

14. The architecture of claim 13, wherein:
a model in a supervisor is navigated to access the site; and
alarms are received from deployed sites.

15. A method for providing a multiple entity configuration, comprising:
creating one or more business groups;
clicking a menu option to add the one or more business groups;
entering an identification of the one or more business groups;
creating one or more sites;
clicking a menu option to add the one or more sites within a business group;
entering an identification of the one or more sites;
creating one or more executives;
clicking a menu option to add the one or more executives within a site;
entering an identification of the one or more executives; and
each site is a business entity having a geographical location.

16. The method of claim 15, wherein the one or more group businesses, sites and executives are displayed in a tree on a screen of a display.

17. The method of claim 15, further comprising:
adding a configuration specific to one or more sites;
entering a destination address of the one or more sites;
deploying the configuration specific to the one or more sites;
deploying the one or more sites;
backing up the one or more sites; and
monitoring one or more deployed sites.

18. The method of claim 17, further comprising navigating an enterprise model in a supervisor to access the one or more deployed sites.

19. The method of claim 17, further comprising viewing alarms from the one or more deployed sites.

20. The method of claim 15, wherein each executive is an HVAC system.
